(19) United States
(12) Patent Application Publication
(10) Pub. No.: US 2016/0217211 A1
(43) Pub. Date: Jul. 28, 2016

(54) Method and System for Identifying Politicians that Better Represent a Voter's Political Priorities

(71) Applicant: Thomas Albert Rabatin, (US)

(72) Inventor: Thomas Albert Rabatin, Albuquerque, NM (US)

(21) Appl. No.: 14/855,450

(22) Filed: Sep. 16, 2015

Related U.S. Application Data
(66) Substitute for application No. 62/107,383, filed on Jan. 24, 2015.

(51) Int. Cl. G06F 17/30

(52) U.S. Cl. CPC G06F 17/30864; G06F 17/3053

(57) ABSTRACT

The Invention's functions and operations for the politicians' compatibility to a voter's political priorities are disclosed. This includes a voter-politician compatibility score relative to each voter's unique ranking of political priorities. It approximates the likely hood that a politician will address the political priorities of a voter. It assumes that a politicians with a higher voter-politician compatibility score are more likely to address the voter's political priorities. It use an adjudication process to insure fairness and accuracy for the determination of the politician's political priority scores. Integrity and clarity of the adjudication process is insured via drop down menus allowing the voter or politician to view and inspect the basis for a voter-politician (a politician's score for each priority and the associated adjudication judgments and the comments entered by adjudicators). A voter's sample election ballot is created listing offices, candidates and voter-politician compatibility scores.

### BACKGROUND

1. Field of the Invention

The invention relates to the operations of voter service. Specifically, the invention identifies the politician's score for political priorities, allows voters to identify and rank in importance their political priorities and creates a Voter-Politician Compatibility Score. The invention is partially represented at the web site, “MyPoliticalPriorities.com”. When coding has been completed for the invention, the invention will be completely represented at the web site, “MyPoliticalPriorities.com”.

### BACKGROUND OF THE INVENTION

It is difficult if not impossible for a voters to make inform decisions about which politician better represents your political view, your political priorities. In the last New Mexico election, there were 63 political offices with 143 candidates. No voter has the time or the resources necessary to adequately research, follow, review and study so many individual Politicians.

Voter information is chiefly limited to 30 second political commercials, political flyers, the politicians stump speeches and political debates. In depth information about a candidate is difficult to acquire and is not readily available to the voters. It is difficult, if not impossible, for voters to make inform decisions about their candidates.

There are over 900 organizations that rate politicians from the organization's perspective. Each of these organizations address a small slice of the political spectrum of issues i.e. Against Abortions—National Right to Life, Pro-Choice—Planned Parenthood, Agriculture—American Farm Bureau, Animals—Humane Society, Business Chamber of Commerce, Civil Liberties—ACLU, Crime—National Association of Police, Labor—AFL-CIO, Taxes—Freedom Works, Women—YWCA, etc. The website, Votesmart.org, displays the ratings of these organizations for a politician.

None of these organizations capture a voter's unique Political Priorities. None of these political organizations' computer systems cross reference a voter's Political Priorities to the politician's Political Priorities. None of these computer systems score the compatibility of a politician to issues that are important to a voter. None of these websites has a transparency as to the basis and the method of rating politicians. This creates a voter credibility issue with politician ratings. Presently, for a voter to gain complete knowledge of a politician's political positions, political priorities, as compared to the voter's political positions, political priorities, requires a considerable amount of the voter's time to search through these political websites for each of politicians' ratings and the basis of these ratings. For each election, this process must be repeated if the voter hopes to gain some knowledge of the politicians' political positions, political priorities.

### SUMMARY OF THE INVENTION

The invention generates a relative comparability score of the politician's political positions, political priorities, to the voter's political positions, their political priorities. It is relative score because it is unique and different for each voter based on their unique rankings of their political positions, political priorities. The higher Voter-Politician Compatibility Score reflects the greater potential that the politician will be a better representative of that voter's political priorities. This is better solution to the problem of “voters not knowing which politician would best represent their political priorities” and “voters not making, a more informed decision”. The invention significantly reduces the amount of voter's time for acquiring information on politicians' political positions, political priorities. The voter enters their rankings of their political priorities, just once. As a voter's political priorities change, the invention allows a voter to update and change the voter's political priorities and their associated ranking.

The invention improves the quality of and increases the quantity of politicians' information of their positions on political priorities. The quality of politician information is ensured through the adjudication process for identifying a politician's positions on political priorities. The quantity of politician information is increased via the collective knowledge base of the voting electorate. Any voter can submit a report of their knowledge of a politician's political position, political priority, for review and adjudication. The collective voting electorate monitoring the politicians' political positions, their political priorities, significantly increases the comprehensiveness of identifying the politician's political positions, political priorities. The invention brings transparency and clarity to the determination of a politician's political positions, political priorities. The reports submitted, the responses submitted, the adjudication scores by jurors and the jurors' comments are available for viewing and examining for any given political priority for any given politician.

This is only website that allows the voters to rank their priorities for any given political office, i.e. governor, mayor, sheriff, etc or any type of political office, i.e. federal, state, local, county or city. Thus, Voter-Politician Compatibility Score is relative and unique to each voter.

Matching the voter's political priorities with the corresponding politician's political priorities, the Voter-Politician Compatibility score is generated from the sum of the product of voter's ranking and the politician's adjudicated score for matching political priorities. The Voter-Politician Compatibility Score is comparative to voter's political priority rankings. The politician with the highest Voter-Politician Compatibility Score indicates that this politician is most likely supports the political priorities of the voter better than other politicians with lower Voter-Politician Compatibility Scores. In the interest of transparency and of integrity, the invention allows for voters to review the genesis of any Voter-Politician Compatibility Score to include the voter's political priorities and rankings, the submitted reports and responses, the jurors' adjudication scores and the jurors' comments that generated the politician score by political priority.

A sample ballot is create with the Voter-Politician Compatibility Scores. This ballot has drill down menus that allow the voter to review the basis of each sore: the initial report, the responses and the jurors' scores and comments. This transparency of determining the politician position on a priority does not exist in any other invention. With this information, the voter is in a better position to make an informed voting decision.

Webpage where opponents or alleys of Politicians enter a report, an argument for the Politician's political priority position. The politicians running for the same office are sent emails with the initial report and a link that allows for the entering of a response, a rebuttal. The report and response are sent to randomly selected jurors of voters for their review, judgement and comments. The jurors will determine the degree of truthfulness of the initial report. The jury's average score is attached to Politician's priority.

### BRIEF DESCRIPTION OF DRAWINGS

FIG. 1 illustrates the system allowing voters to select and rank their political concerns (Political Priorities).

FIG. 2 illustrates the adjudication process used to determine politicians' positions on any given political priority.

FIG. 3 illustrates the system to create a Voter-Politician Compatibility Scores.

FIG. 4 illustrates the system for creating Voting Ballots with Voter-Politician Compatibility Scores.

FIG. 5 illustrates the system that creates transparency for Derivation of Voter-Politician Compatibility Scores.

FIG. 6 illustrates the system for displaying the Adjudication Reports and Responses and is associated with FIG. 5

FIG. 7 illustrates the system for displaying Juror Comments and is associated with FIG. 5

FIG. 8 illustrates the system for adding of new political priorities and is associated with FIG 1.

### DETAILED DESCRIPTION

The invention relates to functions and operations of a computerized voting service to determine which candidates are more likely to best represent any given voter. The invention is nonpartisan, neutral and independent of political issues (Political Priorities), of politicians and of political parties. The invention collects, stores organizes, processes and presents information on voters' Political Priorities, on voters' ranking in importance their political priorities, on reports and responses for politicians' positions on Political Priorities and on adjudicated scores of the politicians' positions on Political Priorities. The invention converts raw data into useful information that assist the voter in determining for which candidates to vote. The invention is not an advocacy for any political issue, politician or political party. No other invention uses a jury system which we call adjudication process to gauge the true political priorities of politicians. It would take hours if not days to acquire the information as to which politicians would best represent them. No other invention allows voters to enter their political priorities and to rank these political priorities by type of office (All, Federal, State, County, City and/or Congressional District). This will be as unique for voters as finger prints are unique. This invention significantly reduces the time to acquire the information as to which politicians would best represent them just 5 minutes. The is one-time 5 minutes expenditure of time used for the signing up of the service and the selecting and ranking of the voter's Political Priorities. No other invention presence the information in a voting ballot format with Voter-Politician Compatibility Scores. No other invention provides the transparency in how politicians are scored on Political Priorities. The domain name/website fur the invention is ‘MyPoliticalPriorities.com’.

Voters know their positions on political issues (Political Priorities) and can ranked them in order of importance. The invention allows voters to enter their Political Priorities and to rank each in importance to that voter. This Voters' ranking of Political Priorities is unique. The invention facilitates the voters' ability to quickly identify which candidate would likely represent them the best. The identification of which candidate would likely represent the voter is based on empirical data of the voter's Political Priorities and the voter's ranking of each Political Priority and the adjudicated scoring of the politician's positions on Political Priorities. This empirical data uses a proprietary numeric calculation to determine a relative Voter-Politician Compatibility Score. The Voter-Politician Compatibility Score is relative to each individual voter and the associated politicians. The Voter-Politician Compatibility Score is unique for the voter and politician and has little or no relationship to the Voter-Politician Compatibility score for a different voter and different or same politicians.

Once a Voter-Politician Compatibility Scores are generated for a voter and multiple politicians, the voter can compare Voter-Politician Compatibility Scores for these politicians to determine which politicians' scores are higher. A politician with a higher Voter-Politician Compatibility Score based on empirical historic data for that politician and the voter's Political Priorities and their ranking is more likely to better represent that voter's Political Priorities. Because the data is exact for the voter and approximate for the politician, the voter is in a better position to determine for which politician to vote.

In one embodiment of the invention, voter service, the non-partisan and neutral process of adjudication for the gathering, the examining and the scoring of politicians' positions on Political Priorities resolves problems in the presence of noisy, partisan, ambiguous, confusing and complex data. In addition, The Voter Service can use the data to assist in improving the predictably of politicians to heed to the Political Priorities of voters.

Voters want to vote for the candidate that best represents their views and beliefs. Under the current system, it is nearly impossible for voters to determine the politicians that would best represent the voters. With the demands of living, voters don't have the time nor the resources necessary to research, follow, review and study candidates. Currently and unfortunately, voter information about candidates is basically limited to 30 second political commercials, political flyers, the politicians stump speeches and political debates. In depth historical information about a candidate is difficult for a voter to acquire and is not readily available to the voters. Under the current political system, it is difficult, if not impossible, for voters to make inform decisions about their candidates. Under the current system to acquire this knowledge is exhaustively time consuming.

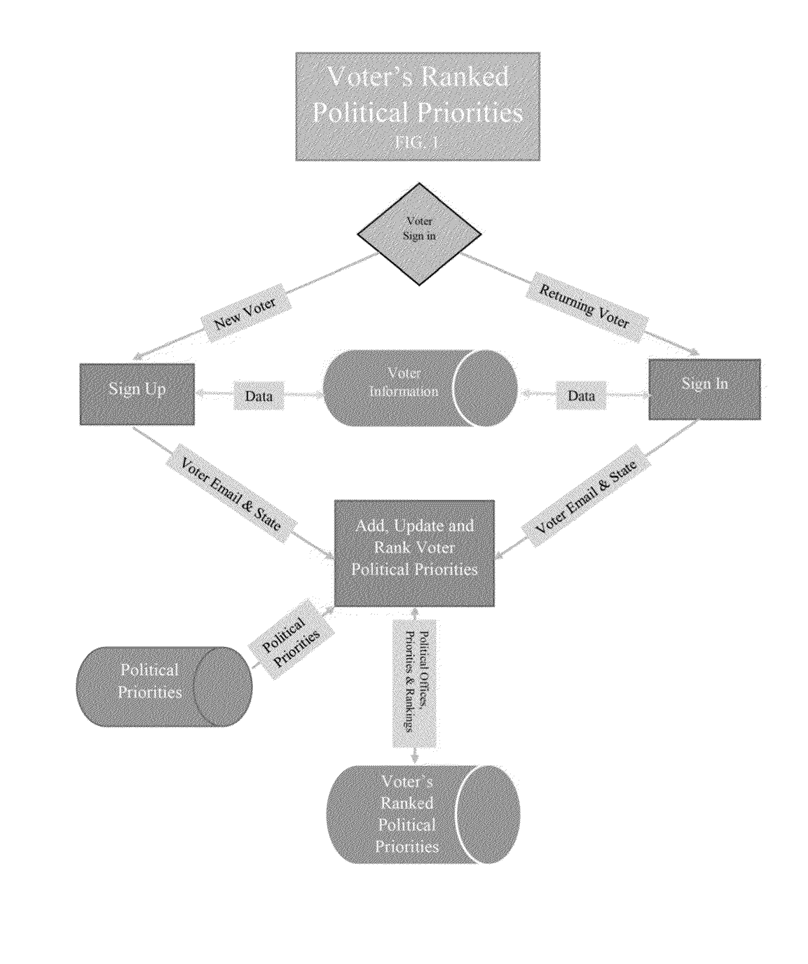

FIG. 1 illustrates the system that allows voters to select and rank their political concerns (Political Priorities). Voters will select from a list of Political Priorities, chose ‘for’ or ‘against’ and rank each Political Priority. Voters can rank Political Priorities from 1 to 100 with 100 meaning very important and 1 mean not very important. The application of the selecting and ranking of Political Priorities, political concerns by voters is unique and distinctive not found anywhere on the World Wide Web.

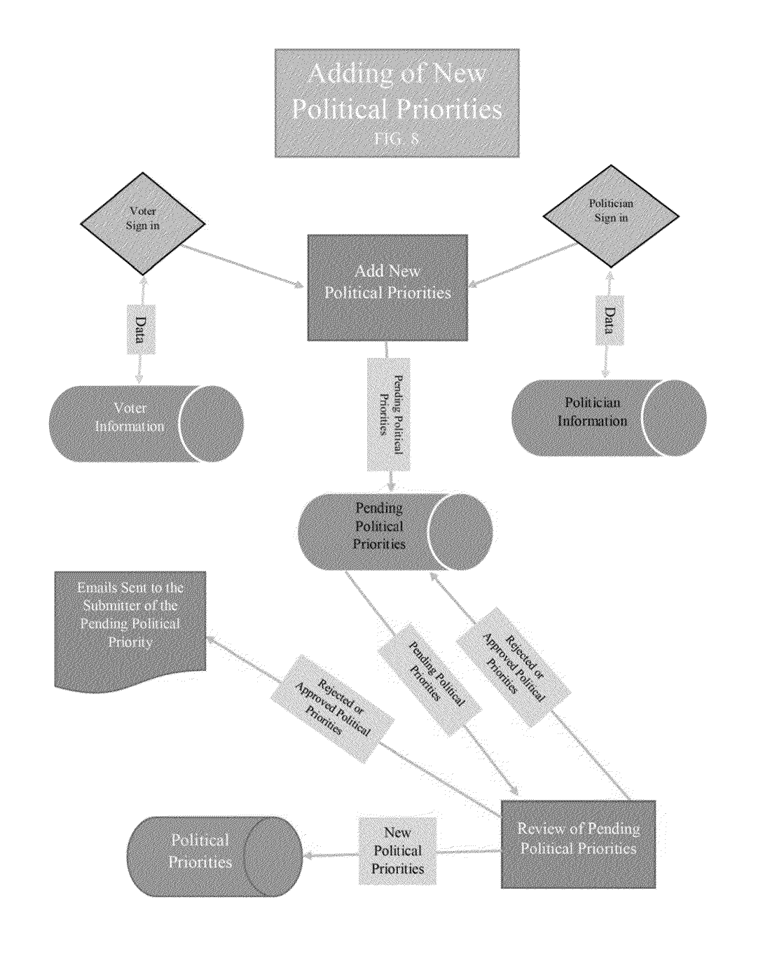

FIG. 8 illustrates the system for adding of new political priorities and is associated with FIG 1. It recognized that Political Priorities derive their origins and meaning from Voters and Politicians. Therefore, either voters or politicians can submit a new pending Political Priority for duplication review to an existing Political Priorities. Duplicate pending Political Priories are rejected and an email is sent to the submitter notifying them of status of their Political Priority and the associated current Political Priority which currently is very similar to their pending Political Priority. For approved Political Priorities, emails are sent to the submitter to notify them that the Pending Political Priority is approved, has been added to the list of Political Priorities and is available for selection and ranking. The application of being able to add Political Priorities by a voter or by a politician is unique and distinctive riot found anywhere on the World Wide Web.

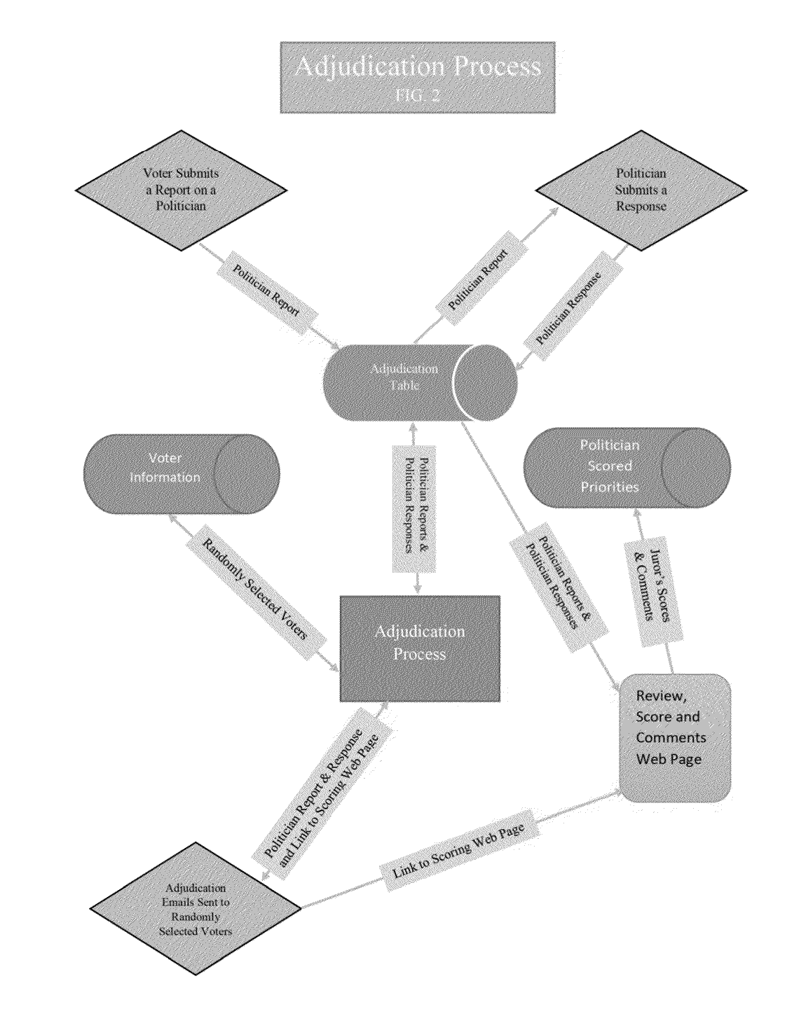

FIG. 2 illustrates the adjudication process used to determine politicians' positions on any given political priority. Politicians have positions on political issues (Political Priorities) and a political history that reflects the politicians' positions on Political Priorities. Voters are very skeptical of politicians honesty in regards to their Political Priorities. With the collective watchful eyes of the electorate, the adjudication process brings clarity to the true political position of politicians. This adjudication process allows for the submission of reports by voters or politicians on a politician's positions on Political Priorities. The ‘reported on’ politician and the other politicians running for the same office are given an opportunity to respond to this report. The initial report and the responses stored in the Adjudication database are submitted to a randomly selected jury of voters. Each juror reviews the initial report and the responses and makes a judgement on the initial report. Because very few things are absolute, each juror will submit a sliding scale judgement score of between −1 and +1. −1 means that initial report is absolutely false. +1 means that the initial report is absolutely true. The average of these “Pinocchio Scores” becomes the politician's position on that priority. This process is modeled after a typical trial proceeding where witnesses and evidence and rebuttal witnesses and rebuttal evidence are presented to a jury of our peers. The application of this adjudication process which brings clarity to politicians' positions is unique and distinctive not found anywhere in the World Wide Web.

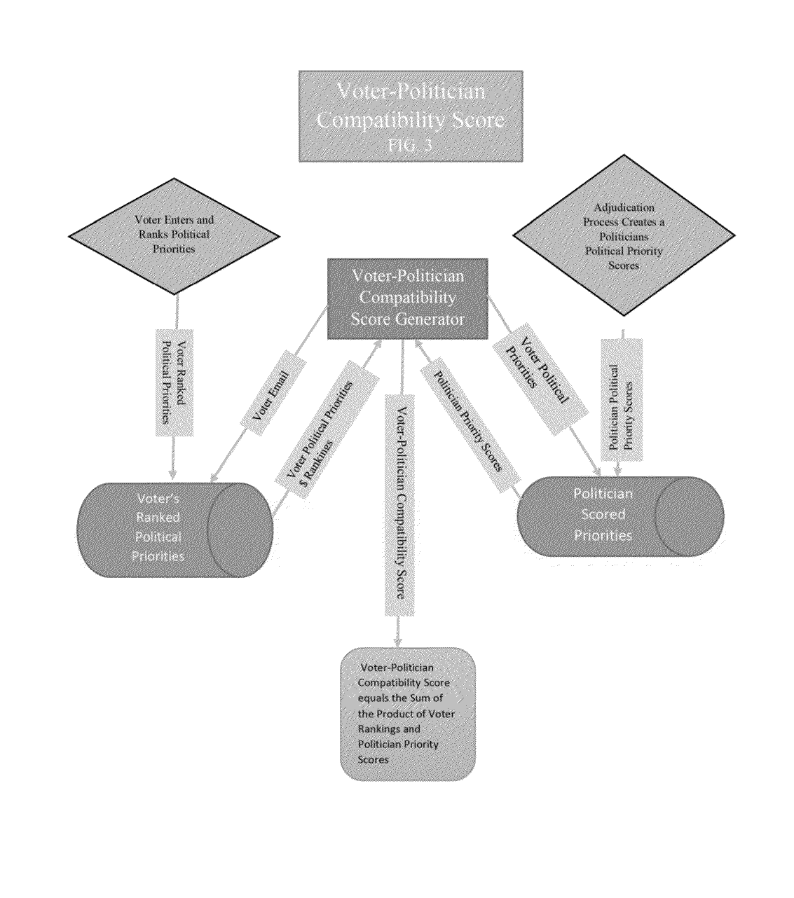

FIG. 3 illustrates the system to create a Voter-Politician Compatibility Scores. This invention creates a voter-politician compatibility score. The Voter-Politician Compatibility Score is based on the voter's Political Priorities and the voter's ranking of these Political Priorities. The set of Political Priorities and their rankings are unique to each voter. No other website or process allows voters to enter and rank their Political Priorities. The invention uses the stored voter's ranked Political Priorities and the stored politician scored priories to create a relative Voter-Politician Compatibility Score. The Voter-Politician Compatibility Score is the sum of the product of the voter's ranking of each Political Priority with the politician's adjudicated score for that corresponding Political Priority. When there is not a matching political priority, the product value is zero. This is a unique process. Nowhere on the World Wide Web is a Voter-Politician Compatibility score generated.

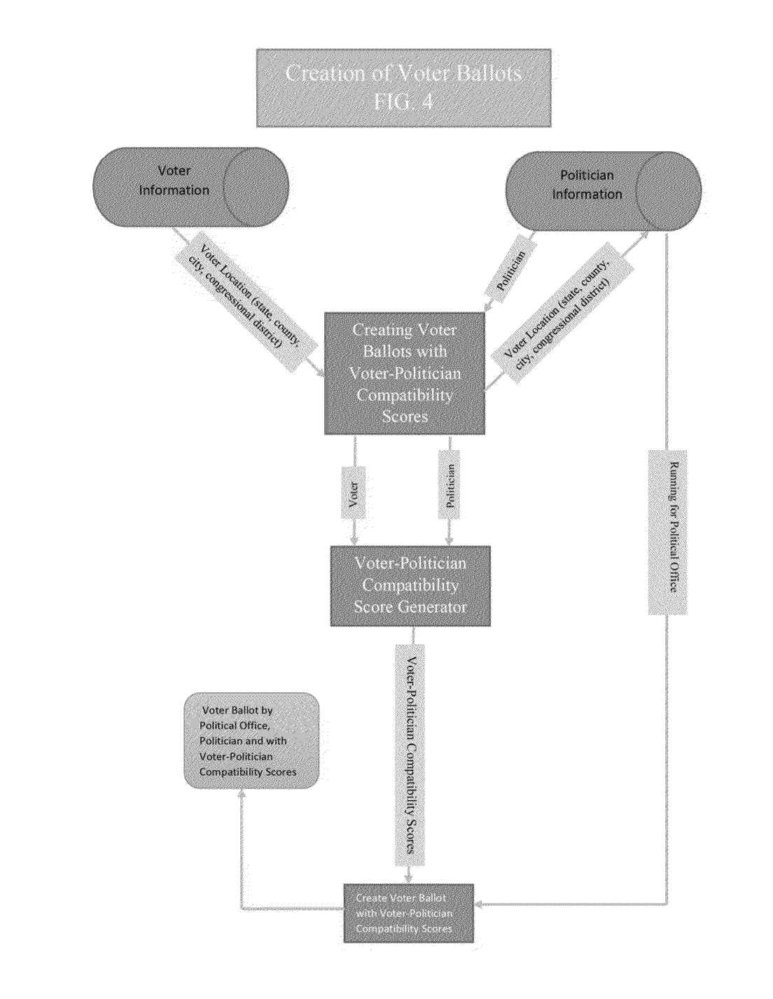

FIG. 4 illustrates the system for creating Voting Ballots with Voter-Politician Compatibility Scores. Using the Voter Information data base and the Politician Information data base, a sample voting ballot is created. Based on the voter's location (state, city, county or parish and congressional district) matching with politicians' information (office, state, city, county or parish and congressional district) a voter ballot can be determined and thus created. From the Voter-Politician Compatibility Score Generator the Voter-Politician Compatibility Scores are added to voting ballot for each of the candidates. The higher the voter-politician compatibility score, the more likely the politician will address the Political Priorities important to that voter. The sample ballot provides an opportunity for the voters to make better and more informed voting decisions. This is a unique process. No other invention creates a sample ballot unique to an individual voter that includes Voter-Politician Compatibility Scores. The Sample Voting Ballot is emailed to the voter. The voter is able to use the Sample Voting Ballot and the associated Voter-Politician Compatibility Scores to make a more informed decision as to the candidate for which the voter should vote.

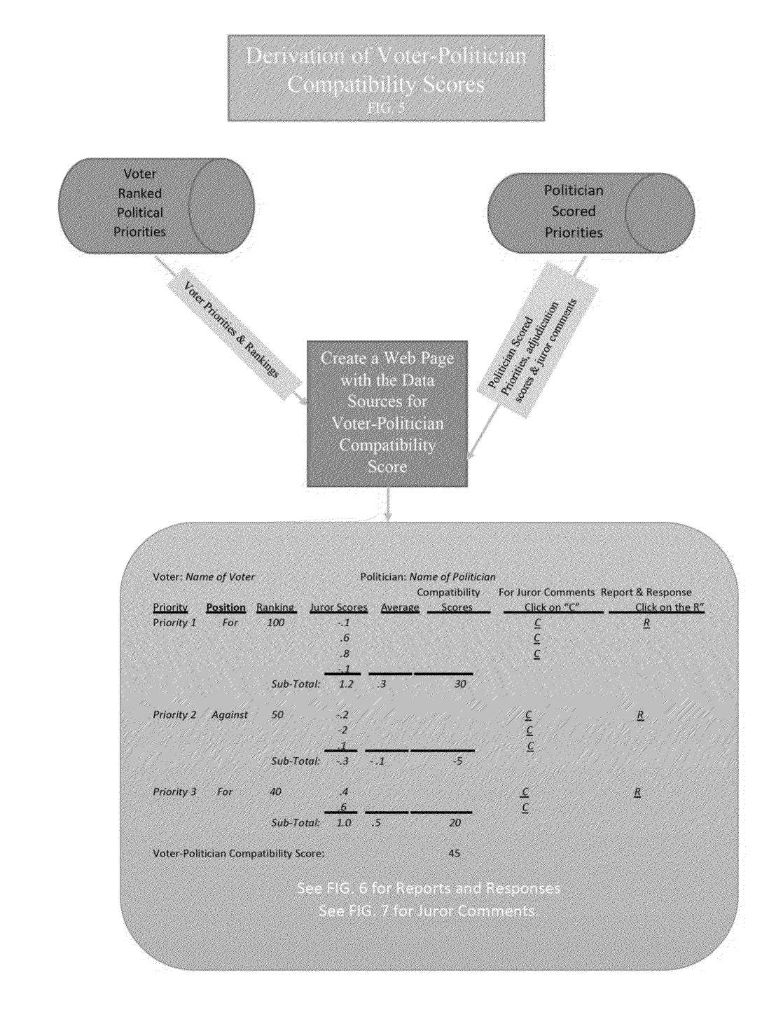

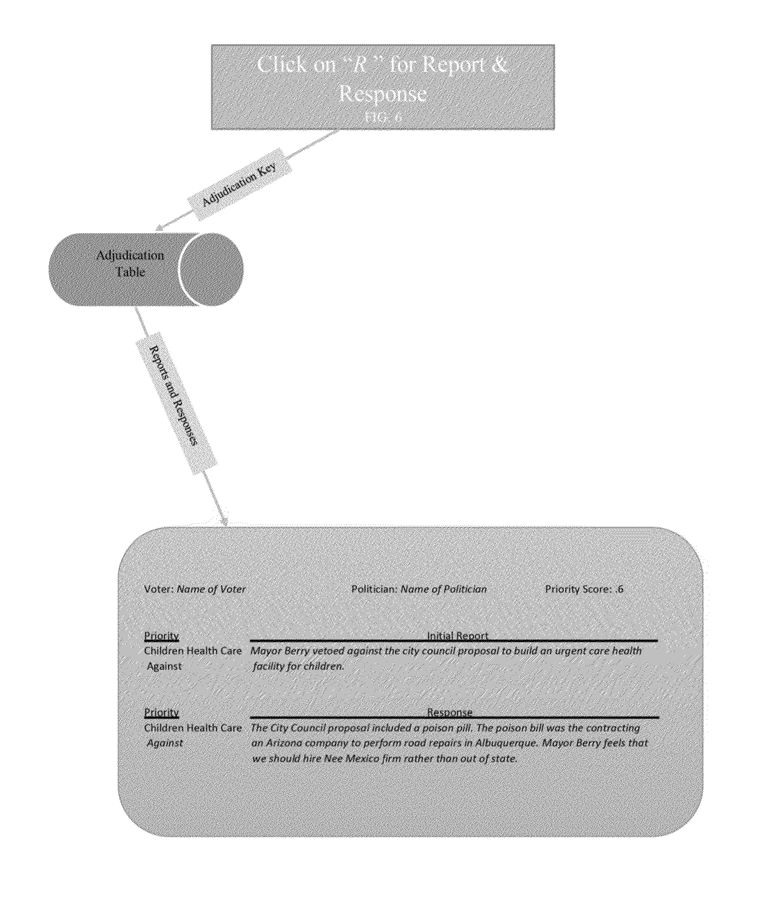

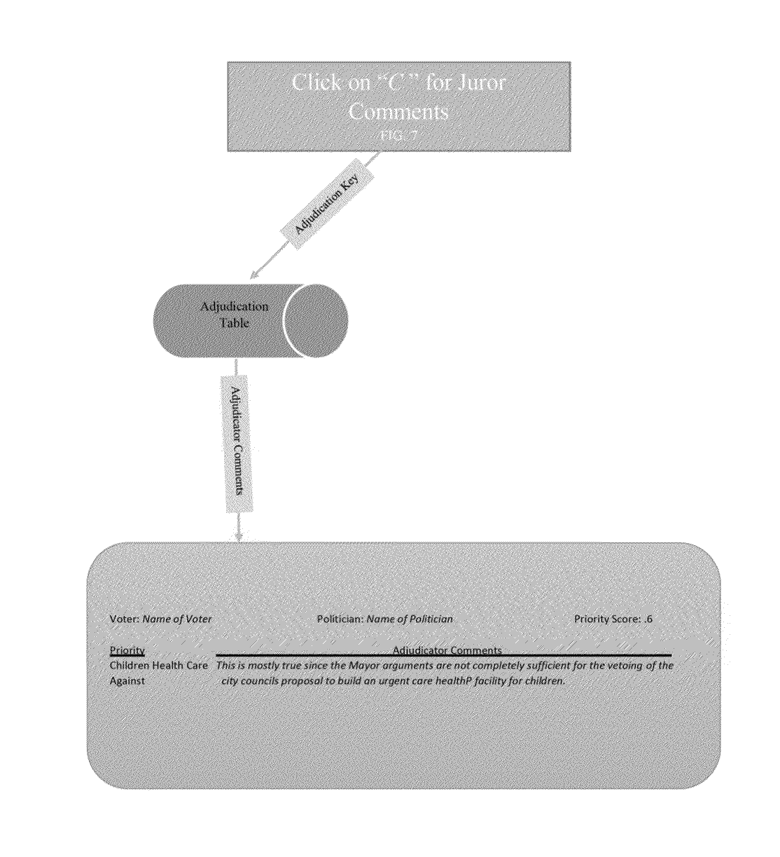

FIG. 5, FIG. 6 and FIG. 7 illustrates the system that creates transparency for Derivation of Voter-Politician Compatibility Scores. Transparency of the adjudication process for scoring politicians' Political Priority scores is created by allowing a voter to review the reports, the responses to these reports, the jurors' scores and the jurors' comments. This process is unique. No political website provides this clarity and transparency for scoring politicians' position on Political Priorities. The few websites that score politicians' positions do not have this transparency as to how the politicians' positions scores were determined. Because this invention stores, organizes and presents information gathered from voters, politicians, reports, responses, adjudicated scores, and voters' comments, this invention is neutral and nonpartisan. This invention converts data into useful information for voters to use in voting for candidates.

FIG 6 illustrates the screen format and content of the Report and Responses. When ‘R’ is clicked the associated report and response is displayed for viewing. Based on an Adjudication Key initial reports and responses are retrieved from the Adjudication Table. The initial reports and responses are formatted and displayed for viewing and inspecting.

FIG. 7 illustrates the screen format and content of the Adjudicator Comments When ‘C’ is clicked the associated Adjudicator Comments are displayed for viewing. Based on an Adjudication Key, the associated Adjudicator Comments are retrieved from the Adjudication Table. The Adjudicator Comments are formatted and displayed for viewing and inspecting.

A product of this invention is that politicians if they want to be elected to an office will need to adhere to the collective priorities of the electorate. This may take several elections cycles before the politicians realize in order to be elected that they must address the Political Priorities of the electorate rather than the Political Priorities of the connected, the powerful and/or the wealthy.

Very few voters have the time or resources to fully vet politicians. This invention reduces the voters' time to vet politicians allowing voters to enter and rank their Political Priorities, to go away, to live their lives and to meet the many demands for just living, to now which politician better represent them and to feel better about their votes.

Most elections are decided by less than 3% differences between the winner and loser. To have an impact on politicians' behavior, the website would only need about 5% of the electorate.

What is claimed:

1. A webpage wherein voters enter and rank their Political Priorities by type of office (All, Federal, State, County, City and/or Congressional District). See Drawing FIG. 1.

2. A computer based adjudication process for determining the politician's positions on political priorities. See Drawing FIG. 2.

3. The method for claim 2 wherein the website via computer programs receives reports of politicians' positions on political priorities and the politicians' responses to these reports.

4. The method for claim 2, wherein these reports and responses via computer programs are submitted through entails to a randomly selected jury of voters for scoring.

5. The method for claim 4, wherein a link from these emails initiates a webpage where each juror views the initial report and responses and scores the initial report using a sliding scale from −1 which means the initial report is totally false and to +1 which means the initial report is totally true.

6. The method for claim 5, jurors can enter a comment about their judgement score of the initial report.

7. The method for claim 2, the average of sum of juror's scoring becomes the politician' political priority score.

8. The method for claim 7, wherein the politician's political priority scores are available for viewing and reviewing.

9. The voter-politician compatibility score is the sum of the products of the voter's ranking of each of their political priorities and the politician's political priority score for each of the voter's political priorities. See Drawing FIG. 3.

10. The method for claim 9, wherein there is not a matching political priority the product value is zero.

11. A computer process for creating voting ballots without accessing state's election data base containing the associated voter-politician compatibility scores for each of the political candidates. See FIG. 4

12. The method for claim 11, wherein based on the voter's location (state, city, county or parish and congressional district) matching with politicians' information (office, state, city, county or parish and congressional district).

13. A transparent computer process for examining the derivation of voter-politician compatibility scores. See FIG. 5, FIG. 6 & FIG. 7.

14. The method for claim 13, wherein are computer drill down webpages of the data used to create the voter-politician compatibility score.

15. The method for claim 13, wherein are computer generated webpages for viewing of the adjudication scores for the voter's political priorities. See FIG. 5.

16. The method for claim 15, wherein are webpages for each of the politician's adjudication score displays the associated submitted reports, responses, jurors' scoring and jurors' comments. See FIG. 6 & FIG. 7.
